(19) United States
(12) Patent Application Publication
(10) Pub. No.: US 2016/0341070 A1
(43) Pub. Date: Nov. 24, 2016

(54) GAS TURBINE ENGINE HAVING ENERGY DISSIPATING GAP AND CONTAINMENT LAYER

(71) Applicant: UNITED TECHNOLOGIES CORPORATION, Farmington, CT (US)

(72) Inventors: Igor S. Garcia, Salem, CT (US); Shu Liu, South Glastonbury, CT (US); Robert Russell Mayer, Manchester, CT (US); Eric Baker, Vernon, CT (US); Stephanie Ernst, Meriden, CT (US); Fernando K. Grant, South Windsor, CT (US); Andrew S. Miller, Marlborough, CT (US); Peter Balawajder, West Hartford, CT (US); Paul W. Palmer, S. Glastonbury, CT (US)

(73) Assignee: United Technologies Corporation, Hartford, CT (US)

(21) Appl. No.: 15/106,566

(22) PCT Filed: Aug. 14, 2014
(86) PCT No.: PCT/US2014/051119

§ 371 Date: Jun. 20, 2016

Related U.S. Application Data
(60) Provisional application No. 61/918,218, filed on Dec. 19, 2013.

(51) Int. Cl. F01D 21/04; F04D 19/00; F04D 29/52; F02C 3/04; F01D 25/24

(52) U.S. Cl. CPC F01D 21/04; F02C 3/04; F01D 25/24; F04D 29/526; F04D 19/002; F05D 2220/32; F05D 2240/35; F05D 2250/283; F05D 2300/6032; F05D 2300/6033; F05D 2300/6012

(57) ABSTRACT

A gas turbine engine includes a containment ring to contain liberated compressor and turbine blades and blade fragments within a core assembly. The combination of a containment gap between the core case and the containment ring and a containment layer disposed in the gap helps dissipate the energy generated by loose body impacts on the core assembly. The containment layer deforms, deflects, and/or redirects the impact energy acting in a radial direction, thereby to improve containment.

### TECHNICAL FIELD

This disclosure generally relates to gas turbine engines, and more particularly to core cases for gas turbine engines.

### BACKGROUND

Gas turbine engines may generally include a fan section coupled to a core assembly. The core assembly may include a compressor section having one or more compressors, a combustion section, and a turbine section having one or more turbines. Each compressor includes multiple compressor blades while each turbine section includes multiple turbine blades. The compressor and turbine blades are disposed within a core case and are rotated rapidly during operation.

It is possible, although unlikely, for a compressor or turbine blade, or a fragment thereof, to separate during operation and strike the core case. Accordingly, core cases are often designed to contain blades and blade fragments, thereby to prevent any liberated material from radially exiting the engine. The demands of blade containment, however, are balanced by the demands for low weight and high strength. Adequate containment is often obtained by increasing the thickness of the core case sufficiently to resistant penetration by a blade or blade fragment. A thicker core case, however, adds weight to the core assembly, thereby reducing engine efficiency.

### SUMMARY OF THE DISCLOSURE

In accordance with one aspect of the disclosure, a gas turbine engine is disclosed. The engine may include a fan assembly and a core assembly coupled to the fan assembly. The core assembly may include a compressor section including at least one compressor having a plurality of compressor blades, a turbine section including at least one turbine having a plurality of turbine blades, a combustor section disposed between the compressor section and the turbine section, a core case surrounding the compressor section, the turbine section, and the combustor section, and defining a core case first surface, a blade containment ring surrounding at least one of the compressor section and the turbine section and defining a containment ring first surface spaced from and oriented towards the core case first surface to define a containment gap therebetween, and a containment layer disposed in the containment gap and configured to dissipate energy from radially projecting impacts.

In accordance with one aspect of the disclosure, a gas turbine engine includes a fan assembly and a core assembly coupled to the fan assembly. The core assembly includes a compressor section, a turbine section, a combustor section disposed between the compressor section and the turbine section, a core case surrounding the compressor section, the turbine section, and the combustor section, and defining a core case first surface, a blade containment ring surrounding at least one of the compressor section and the turbine section and defining a containment ring first surface spaced from and oriented towards the core case first surface to define a containment gap therebetween, and a containment layer disposed in the containment gap and configured to dissipate energy from radially projecting impacts, the containment layer including a plating layer disposed on the containment ring first surface.

In accordance with one aspect of the disclosure a core assembly in a gas turbine engine includes a compressor section, a turbine section, a core case surrounding the compressor section and the turbine section and defining a core case first surface, a blade containment ring surrounding at least one of the compressor section and the turbine section and defining a containment ring first surface spaced from and oriented towards the core case first surface to define a containment gap therebetween, and a containment layer disposed in the containment gap and configured to dissipate energy from radially projecting impacts, the containment layer including a weave layer having woven metal fibers.

### BRIEF DESCRIPTION OF THE DRAWINGS

FIG. 1 is a schematic side elevation view, in partial cross-section, of an exemplary gas turbine engine;

FIG. 2 is an enlarged side elevation view, in cross-section, of a portion of the exemplary gas turbine engine of FIG. 1;

FIGS. 3A and 3B are schematic side elevation views, in cross-section, of exemplary embodiments of containment layers in the form of alternative plating layers disposed in a gap between a containment plate and a core case of the gas turbine engine of FIGS. 1 and 2;

FIGS. 4A and 4B are schematic side elevation views, in cross-section, of an exemplary embodiment of a containment layers in the form of a shape memory alloy, in refracted and expanded states respectively, disposed in a gap between a containment plate and a core case of the case turbine engine of FIGS. 1 and 2;

FIGS. 5A, 5B, and 5C are schematic side elevation views, in cross-section, of exemplary embodiments of containment layers in the form of alternative matrix composite layers disposed in a gap between a containment plate and a core case of the case turbine engine of FIGS. 1 and 2;

FIG. 6 is a schematic side elevation view, in cross-section, of an exemplary embodiment of a containment layer in the form of a filler layer disposed in a gap between a containment plate and a core case of the case turbine engine of FIGS. 1 and 2;

FIG. 7 is a schematic side elevation view, in cross-section, of an exemplary embodiment of a containment layer in the form of a weave layer disposed in a gap between a containment plate and a core case of the case turbine engine of FIGS. 1 and 2;

FIG. 8 is an enlarged perspective view of the weave layer of FIG. 7; and

FIGS. 9A and 9B are schematic side elevation views, in cross-section, of exemplary embodiments of containment layers in the form of resilient layers disposed in a gap between a containment plate and a core case of the case turbine engine of FIGS. 1 and 2.

### DETAILED DESCRIPTION

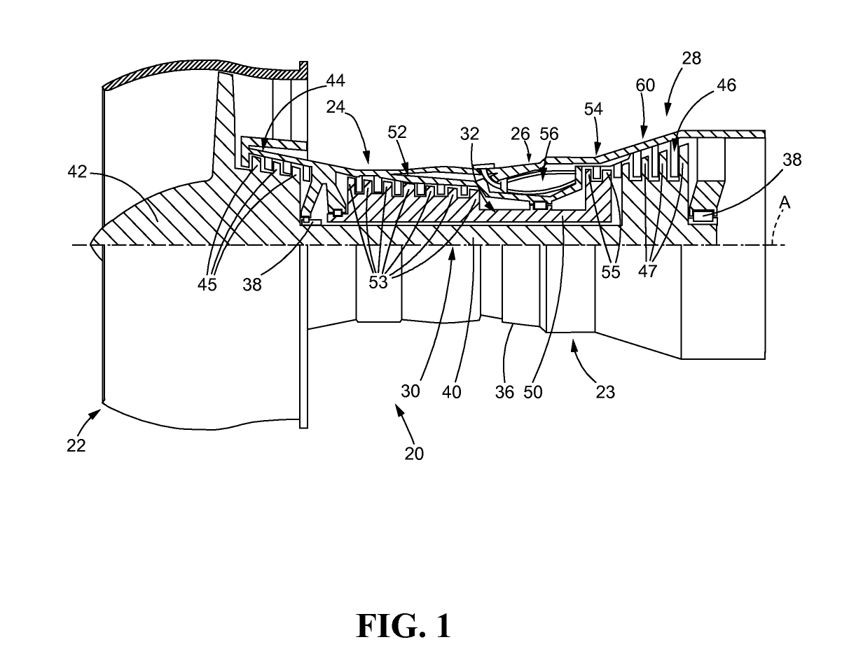

FIG. 1 schematically illustrates an exemplary gas turbine engine 20. The gas turbine engine 20 is disclosed herein as a two-spool turbofan that generally incorporates a fan section 22, and a core assembly 23. The core assembly 23 includes a compressor section 24, a combustor section 26, and a turbine section 28. Alternative engines might include an augmentor section (not shown) or a three-spool architecture among other systems or features. The fan section 22 drives air along a bypass flowpath while the compressor section 24 drives air along a core flowpath for compression, communication into the combustor section 26, and expansion through the turbine section 28. Although depicted as a turbofan gas turbine engine in the exemplary, non-limiting embodiment, it should be understood that the concepts described herein are not limited to use with turbofans as the teachings may be applied to other types of turbine engines.

The engine 20 generally includes a low spool 30 and a high spool 32 mounted for rotation about an engine longitudinal axis A relative to an engine static structure 36 via multiple bearing systems 38. It should be understood that various bearing systems 38 at various locations may alternatively or additionally be provided.

The low spool 30 generally includes an inner shaft 40 that interconnects a fan 42, a low pressure compressor 44, and a low pressure turbine 46. The low pressure compressor 44 includes a plurality of low pressure compressor blades 45, while the low pressure turbine 46 includes a plurality of low pressure turbine blades 47. The low pressure compressor and turbine blades 45, 47 are coupled to and rotate with the inner shaft 40. The inner shaft 40 is further connected to the fan 42 through a geared architecture (not shown) to drive the fan 42 at a lower speed than the low spool 30.

The high spool 32 includes an outer shaft 50 that interconnects a high pressure compressor 52 and high pressure turbine 54. The high pressure compressor 52 includes a plurality of high pressure compressor blades 53, while the high pressure turbine 54 includes a plurality of high pressure turbine blades 55. The high pressure compressor and turbine blades 53, 55 are coupled to and rotate with the outer shaft 50. A combustor 56 is disposed between the high pressure compressor 52 and the high pressure turbine 54. The inner shaft 40 and the outer shaft 50 are concentric and rotate about the engine longitudinal axis A which is collinear with their longitudinal axes.

The core assembly 23 defines a main fluid path, commonly referred to as the core flowpath (not shown), through the engine. Air traveling into the core flowpath is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low spool 30 and high spool 32 in response to the expansion. As used herein, the low pressure compressor 44 and the high pressure compressor 52 may collectively be referred to as “compressors.” Similarly, the low pressure turbine 46 and the high pressure turbine 54 may collectively be referred to as “turbines.”

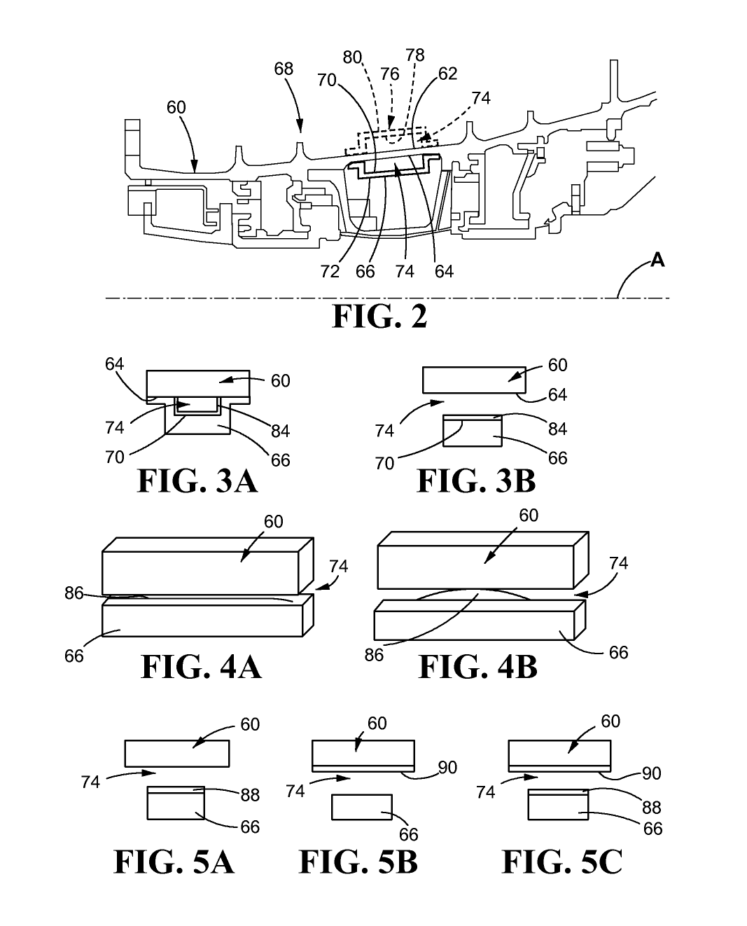

The core assembly 23 further includes a core case 60 that extends rearward from the fan section 22 along the engine axis A and generally surrounds the compressor section 24, the combustor section 26, and the turbine section 28. The core case 60 includes a core case outer surface 62 that may have a perimeter or circumference that is generally annular (FIG. 2). The core case 60 may further include a core case inner surface 64 (FIG. 2).

As best shown in FIG. 2, the exemplary core assembly 23 further includes a blade containment ring 66 positioned to retain compressor and/or turbine blades (or fragments thereof) that may become liberated from their respective shafts. FIG. 2 illustrates a high pressure turbine section 68 of the core assembly 23, where the core case 60 surrounds the high pressure turbine 54 (not shown in FIG. 2). Additional or alternative blade containment rings may be provided in other locations on the core assembly 23 to contain blade or blade fragments from the low pressure compressor 44, the high pressure compressor 52, and the low pressure turbine 46. While the containment ring 66 is described herein primarily in conjunction with its ability to contain liberated blades or blade fragments, it will be appreciated that the containment ring 66 may also serve other functions in the engine, such as a vane support or a seal support.

The blade containment ring 66 is disposed inside the core case 60 and includes a containment ring first surface 70 facing toward the core case inner surface 64 and a second containment ring surface 72 facing away from the core case 60 and toward the engine longitudinal axis A. The containment ring first surface 70 is spaced from the core case inner surface 64 to define a containment gap 74 therebetween. While the gap 74 is described herein primarily in conjunction with its ability to contain liberated blades or blade fragments, it will be appreciated that the gap 74 may also serve other functions in the engine, such as a passage for cooling air, control air, or instrumentation. The blade containment ring 66 may be directly coupled to the core case 60 as shown, or may be supported independent of the core case 60.

FIG. 2 also illustrates, in phantom, an alternative location for a blade containment ring 76 disposed outside the core case 60. The blade containment ring 76 includes a containment ring first surface 78 facing toward the core case outer surface 62 and a second containment ring surface 80 facing away from the core case 60. The containment ring first surface 78 is spaced from the core case outer surface 62 to define the containment gap 74 therebetween.

A containment layer is disposed in the containment gap 74 gap and configured to dissipate energy from radially projecting impacts, thereby to help contain blade and/or blade fragments that may be liberated from the turbines and/or compressors. In the embodiment illustrated at FIGS. 3A and 3B, the containment layer is shown as a plating layer 84 disposed on the containment ring first surface 70 of the containment ring 66. In FIG. 3A, the containment ring 66 is configured to directly attach to the core case 60, while in FIG. 3B the containment ring 66 is not directly coupled to the core case 60. In both embodiments, the plating layer 84 is formed directly on the containment ring first surface 70. The plating layer 84 may be formed of a malleable alloy or metal, such as copper. The plating layer 84 may be formed on the containment ring first surface 70 by plating, coating, transient liquid phase (“TLP”) bonding, or other methods that place the plating layer 84 in intimate contact with the containment ring first surface 70. Alternatively, the plating layer 84 may be formed on the core case inner surface 64 and disposed within the containment gap 74.

In an alternative embodiment illustrated at FIGS. 4A and 4B, the containment layer may be provided as a shape memory layer disposed within the containment gap 74. The shape memory layer may be a shape memory alloy structure 86 that is responsive to temperature. More specifically, at relatively low temperatures, the shape memory alloy structure 86 may assume a retracted state as shown in FIG. 4A. At relatively high temperatures, such as when the gas turbine engine is operating, the shape memory alloy structure 86 may expand to assume an expanded state as shown in FIG. 4B. In the expanded state, the shape memory alloy structure 86 may maintain the containment gap 74 between the core case 60 and the containment ring 66. Additionally, the shape memory alloy structure 86 may be configured to dissipate energy from radial impacts, thereby to improve containment of liberated blades or blade fragments. More specifically, during operation the rise in core temperature will deform the shape memory alloy layer to create the gap 74 between the core case 60 and the containment ring 66, which gap may advantageously improve energy dissipation when impacted by a foreign body.

The shape memory alloy structure 86 may be coupled to either the core case 60 or the containment ring 66, or both the core case 60 and containment ring 66. While the shape memory alloy structure 86 is shown having a convex shape in the expanded state, it will be appreciated that it may be configured to assume other shapes. Furthermore, multiple discrete shape memory alloy structures may be disposed between the core case 60 and the containment ring 66.

FIGS. 5A-C illustrate additional alternative embodiments of containment layers in the form of matrix composite layers. In FIG. 5A, for example, a first matrix composite layer 88 is disposed in the containment gap 74 and coupled to the containment ring 66. In FIG. 5B, a second matrix composite layer 90 is disposed in the containment gap 74 and coupled to the core case 60. In FIG. 5C, both the first and second matrix composite layers 88, 90 are provided in the containment gap 74. The matrix composite layers may be formed of a matrix composite material, such as a metal matrix composite, a ceramic matrix composite, a metal honeycomb composite, or an organic matrix composite. The structure and material properties of the matrix composite layer may dissipate energy in several directions simultaneously while dampening energy traveling within the impacted layers to improve containment of a blade or blade fragment. Additionally or alternatively, by using dissimilar materials with different mechanical and physical properties, each layer may have a different energy dissipation rate upon impact by a foreign body, which may improve the structural stability of the core case 60. Furthermore, different types of material combinations for the layers may have differently sized gaps for optimizing energy dissipation (and therefore containment of blades or blade fragments).

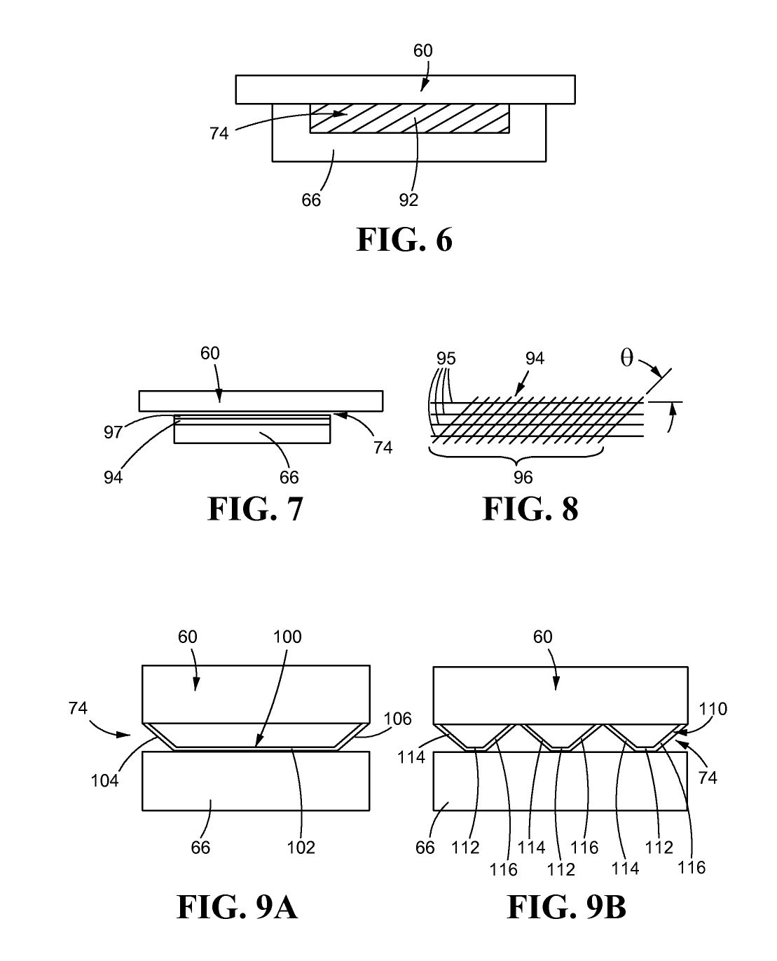

FIG. 6 illustrates another alternative embodiment of a containment layer in the form of a filler layer 92. The filler layer 92 is configured to substantially entirely fill the containment gap 74. The filler layer 92 may be formed of a filler material that can withstand elevated temperatures reached during operation of the gas turbine engine and is configured to absorb energy, such as a ceramic material or a non-Newtonian fluid.

FIGS. 7 and 8 illustrate yet another alternative embodiment of a containment layer in the form of a weave layer 94. As shown in FIG. 7, the weave layer 94 is disposed in the containment gap 74 and may overlie a surface of the containment ring 66 as shown or the core case 60. As best shown in FIG. 8, the weave layer 94 may include metal fibers that are woven together. The weave layer 94 may include a first set of fibers 95 oriented along a first fiber direction and a second set of fibers 96 oriented along a second fiber direction, and the second fiber direction forms a fiber angle θ relative to the first fiber direction. The fiber angle θ may be selected to optimize containment. Optionally, the containment layer may further include additional weave layers, such as a second weave layer 97 of woven metal fibers. In operation, the metal fibers will stretch in response to redial impacts by blades or blade fragments, thereby to dissipate energy and improve containment.

FIGS. 9A and 9B illustrate further embodiments of a containment layer in the form of resilient layers. As shown in FIG. 9A, a resilient layer 100 is disposed in the containment gap 74 between the core case 60 and the containment ring 66. In the illustrated embodiment, the resilient layer 100 includes a base 102 extending between two arms 104, 106. The resilient layer 100 is formed of a high temperature resistant, resilient material that is configured to produce a force biasing the core case 60 away from the containment ring 66, thereby to maintain the containment gap 74. The resilient layer 100 will absorb at least a portion of the energy produced by a radial impact, thereby to improve containment. Additionally, the resilient layer 100 improves thermal isolation of the core case 60. FIG. 9B illustrates a resilient layer 110 similar to the resilient layer 100, but has a different structure. More specifically, the resilient layer 110 includes multiple base segments 112 each having a pair of arms 114, 116 attached thereto.

### INDUSTRIAL APPLICABILITY

In operation, the containment ring 66 helps improve containment of liberated blades and blade fragments within the core assembly 23. The combination of the containment gap 74 between the core case 60 and the containment ring 66 and a containment layer disposed in the gap helps dissipate the energy generated by a blade or blade fragment impacting the core assembly 23. The containment layer embodiments will deform, deflect, and/or redirect the impact energy acting in a radial direction, thereby to improve containment. Additionally or alternatively, the containment layer may change the rate of energy exchange between the core case 60 and the containment ring 66, so that the interplay between these layers may increase the amount of energy dissipation when compared to conventional, monolithic structures that may occupy the same volume and space as the multi-layer assemblies disclosed herein.

What is claimed is:

1. A gas turbine engine disposed along a longitudinal engine axis, the gas turbine engine comprising:
a fan assembly;
a core assembly coupled to the fan assembly, the core assembly including:
a compressor section including at least one compressor having a plurality of compressor blades;
a turbine section including at least one turbine having a plurality of turbine blades;
a combustor section disposed between the compressor section and the turbine section;
a core case surrounding the compressor section, the turbine section, and the combustor section, and defining a core case first surface;
a blade containment ring surrounding at least one of the compressor section and the turbine section and defining a containment ring first surface spaced from and oriented towards the core case first surface to define a containment gap therebetween; and
a containment layer disposed in the containment gap and configured to dissipate energy from radially projecting impacts.

2. The gas turbine engine of claim 1, in which the core case first surface comprises a core case inner surface and the containment ring first surface comprises a containment ring outer surface, so that the containment ring is disposed nearer to the core longitudinal axis than the core case.

3. The gas turbine engine of claim 1, in which the core case first surface comprises a core case outer surface and the containment ring first surface comprises a containment ring inner surface, so that the containment ring is disposed farther from the core longitudinal axis than the core case.

4. The gas turbine engine of claim 1, in which the containment ring is directly coupled to the core case.

5. The gas turbine engine of claim 1, in which the containment layer comprises a plating layer disposed on the containment ring first surface.

6. The gas turbine engine of claim 5, in which the plating layer is formed of a malleable metal or malleable metal alloy.

7. The gas turbine engine of claim 1, in which the containment layer comprises a temperature-responsive shape memory layer having a retracted state at a relatively low temperature and an expanded state at a relatively high temperature.

8. The gas turbine engine of claim 1, in which the containment layer comprises a matrix composite layer.

9. The gas turbine engine of claim 8, in which the matrix composite layer comprises a matrix composite material selected from a group of matrix composite materials consisting of a metal matrix composite, a ceramic matrix composite, a metal honeycomb composite, and an organic matrix composite.

10. The gas turbine engine of claim 1, in which the containment layer comprises a filler layer configured to substantially entirely fill the containment gap.

11. The gas turbine engine of claim 10, in which the filler layer comprises a filler material selected from a group of filler materials consisting of a ceramic material and a non-Newtonian fluid.

12. The gas turbine engine of claim 1, in which the containment layer comprises a weave layer having woven metal fibers.

13. The gas turbine engine of claim 1, in which the containment layer comprises a resilient layer.

14. A gas turbine engine disposed along a longitudinal engine axis, the gas turbine engine comprising:
a fan assembly;
a core assembly coupled to the fan assembly, the core assembly including:
a compressor section;
a turbine section;
a combustor section disposed between the compressor section and the turbine section;
a core case surrounding the compressor section, the turbine section, and the combustor section, and defining a core case first surface;
a blade containment ring surrounding at least one of the compressor section and the turbine section and defining a containment ring first surface spaced from and oriented towards the core case first surface to define a containment gap therebetween; and
a containment layer disposed in the containment gap and configured to dissipate energy from radially projecting impacts, the containment layer including a plating layer disposed on the containment ring first surface.

15. The gas turbine engine of claim 14, in which the plating layer is formed of a malleable metal or malleable metal alloy.

16. The gas turbine engine of claim 14, in which the plating layer is formed of copper.

17. The gas turbine engine of claim 14, in which the plating layer is formed on the containment ring first surface by plating, coating, or transient liquid phase bonding.

18. A core assembly in a gas turbine engine, the core assembly comprising:
a compressor section;
a turbine section;
a core case surrounding the compressor section and the turbine section and defining a core case first surface;
a blade containment ring surrounding at least one of the compressor section and the turbine section and defining a containment ring first surface spaced from and oriented towards the core case first surface to define a containment gap therebetween; and
a containment layer disposed in the containment gap and configured to dissipate energy from radially projecting impacts, the containment layer including a weave layer having woven metal fibers.

19. The core assembly of claim 18, in which the weave layer comprises a first set of fibers oriented along a first fiber direction and a second set of fibers oriented along a second fiber direction, and in which the second fiber direction forms a fiber angle θ relative to the first fiber direction.

20. The core assembly of claim 18, in which the containment layer further comprises a second weave layer of woven metal fibers.
